(19) United States
(12) Patent Application Publication
(10) Pub. No.: US 2021/0026807 A1
(43) Pub. Date: Jan. 28, 2021

(54) METHOD FOR MANAGING DATA ASSOCIATED WITH APPLICATION AND ELECTRONIC DEVICE THEREFOR

(71) Applicant: Samsung Electronics Co., Ltd., Suwon-si, Gyeonggi-do (KR)

(72) Inventors: Daeho JEONG, Suwon-si (KR); Minjung KIM, Suwon-si (KR)

(21) Appl. No.: 16/966,992

(22) PCT Filed: Feb. 13, 2019
(86) PCT No.: PCT/KR2019/001755

§ 371 Date: Aug. 3, 2020

(30) Foreign Application Priority Data
Feb. 14, 2018 (KR) 10-2018-0018559

(51) Int. Cl. G06F 16/16; G06F 8/61

(52) U.S. Cl. CPC G06F 16/164; G06F 8/61

(57) ABSTRACT

The present invention relates to an apparatus and a method for managing data associated with an application that is not used in an electronic device. The electronic device may comprise instructions by which: at least one application program is downloaded from an external server through a communication circuit; at least one application program is installed in the electronic device; a file system is provided and is configured to store, in at least one first area of a non-volatile memory, at least one file used by the at least one application program; metadata, which is associated with at least one file, is stored in at least one second area of a non-volatile memory by using a file system, wherein the metadata includes information of the at least one application program; at least one application program is deleted from the electronic device; and at least one file is deleted on the basis of at least a part of the metadata during deletion or after deletion of the at least one application program.

### TECHNICAL FIELD

Various embodiments of the disclosure relate to an apparatus and a method for managing data associated with an application in an electronic device.

### BACKGROUND ART

With the development of information and communications technology and semiconductor technology, various kinds of electronic devices are developing into multimedia devices providing various multimedia services. For example, the multimedia services may include at least one of a voice communication service, a message service, a broadcasting service, a wireless Internet service, a camera service, an electronic payment service or a music replay service.

An electronic device may have at least one application installed therein to provide various services needed by a user. For example, the electronic device may have a music application for replaying a sound source desired by the user, a call application for a voice call service, a camera application for a camera service installed therein.

### DISCLOSURE OF INVENTION

### Technical Problem

An electronic device may generate data (for example, a folder and a file) associated with a corresponding application for each application, and may store the data in at least a portion of a memory. For example, the electronic device may generate dedicated folders for respective applications in the memory, and may store data associated with each application. According to an embodiment, an application may generate or store at least one data associated with the application in a folder (for example, a root folder or a shared folder of an internal storage of an operating system) other than the application-dedicated folder.

When the application is deleted, the electronic device may not delete at least a part of the data associated with the application. For example, the electronic device may not identify at least a part of the data associated with the application that is stored in the folder other than the application-dedicated folder, and at least a part of the data associated with the deleted application may not be deleted and may remain in the memory. Since the data associated with the application that is not deleted is stored in the memory without being used by the electronic device, a storage space of the electronic device may be unnecessarily consumed by the corresponding data.

Various embodiments of the disclosure provide an apparatus and a method for managing data associated with an application in an electronic device.

### Solution to Problem

According to various embodiments of the disclosure, an electronic device includes: a communication circuit; a processor operatively connected with the communication circuit; and a nonvolatile memory electrically connected with the processor, and the memory stores instructions that, when executed, cause the processor to: download at least one application program from an external server through the communication circuit; install the at least one application program in the electronic device; provide a file system which is configured to store at least one file that is used by the at least one application program in at least one first region of the nonvolatile memory; store metadata associated with the at least one file in at least one second region of the nonvolatile memory by using the file system, the metadata including information of the at least one application program; delete the at least one application program from the electronic device; and in the middle of deleting the at least one application program or after deleting, delete the at least one file based on at least a portion of the metadata.

According to various embodiments of the disclosure, an operating method of an electronic device includes: storing, through a file system of the electronic device, at least one file that is used by at least one application program in at least one first region of a nonvolatile memory; storing metadata associated with the at least one file in at least one second region of the nonvolatile memory by using the file system, the metadata including information of the at least one application program; and, in response to the at least one application program being deleted from the electronic device, deleting the at least one file based on at least a portion of the metadata.

### Advantageous Effects of Invention

The electronic device and the operating method therefor according to various embodiments add application information to data (file or folder) generated or accessed by an application by using the file system, such that data associated with an application that is not used in the electronic device can be easily extracted and managed (for example, deleted), and availability of a storage device can increase.

### BRIEF DESCRIPTION OF DRAWINGS

FIG. 1 is a block diagram of an electronic device for managing data associated with an application in a network environment according to various embodiments of the disclosure;

FIG. 2 is a block diagram of a program according to various embodiments of the disclosure;

FIG. 3 is a block diagram of a program for managing a file associated with an application according to various embodiments of the disclosure;

FIG. 4 is a view illustrating a structure for adding a file associated with an application according to various embodiments of the disclosure;

FIG. 5 is a flowchart for managing a file associated with an application in an electronic device according to various embodiments of the disclosure;

FIG. 6 is a view illustrating a structure on a disk of a system according to various embodiments of the disclosure;

FIG. 7 is a flowchart for managing a file based on another application information in an electronic device according to various embodiments of the disclosure;

FIG. 8 is a flowchart for managing a file based on an auto setting function in an electronic device according to various embodiments of the disclosure;

FIG. 9 is a view illustrating a configuration of a delete inquiry message according to various embodiments of the disclosure;

FIG. 10 is a flowchart for displaying a deletable file to be distinguished in a file list in an electronic device according to various embodiments of the disclosure; and

FIGS. 11A and 11B are views illustrating a configuration of a file list including a deletable file according to various embodiments of the disclosure.

### BEST MODE FOR CARRYING OUT THE INVENTION

Various embodiments of the present disclosure are described below in detail with reference to the accompanying drawings. And, in describing an embodiment of the present disclosure, related well-known functions or constructions are not described in detail since they would obscure the gist of the present disclosure in unnecessary detail. And, the terms described below, which are terms defined considering functions of the present disclosure, may be modified according to user and operator's intention or practice, etc. Therefore, the definition should be given on the basis of the content throughout the present specification.

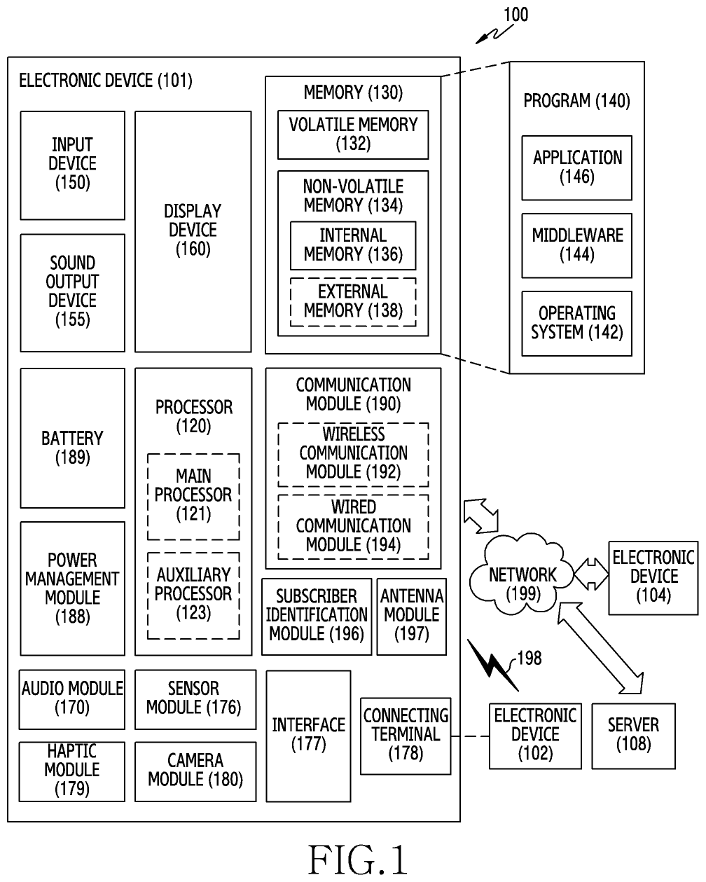

FIG. 1 is a block diagram of an electronic device 101 for managing data associated with an application in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wired) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wired) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector),

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BLUETOOTH, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other.

The wireless communication module 192 may identify and authenticate the electronic device 101 in a communication network, using subscriber information stored in the subscriber identification module 196.

The antenna module 197 may include one or more antennas for transmitting a signal or power to the outside or receiving it from the outside. According to an embodiment, the communication module 190 (e.g., the wireless communication module 192) may transmit a signal to an external electronic device through an antenna suitable for a communication method, or receive a signal from the external electronic device.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

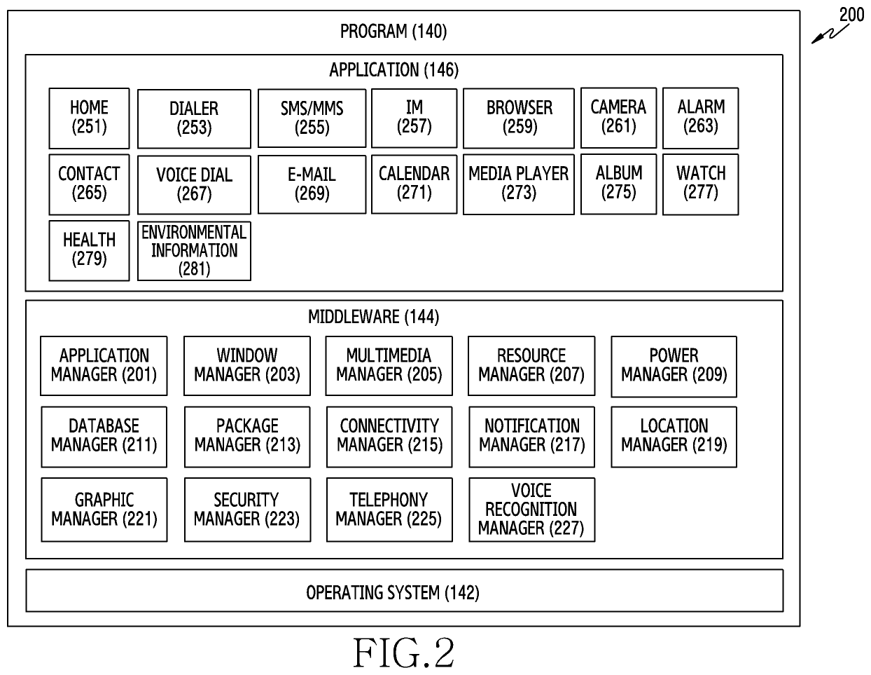

FIG. 2 is a block diagram 200 illustrating the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227. The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects. The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MIMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application, for example, may transmit notification information corresponding to an event (e.g., receiving mail) generated in another application (e.g., email application (269)) of the electronic device 101 to an external electronic device, or receive notification information from an external electronic device and provide it to a user of the electronic device 101. The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

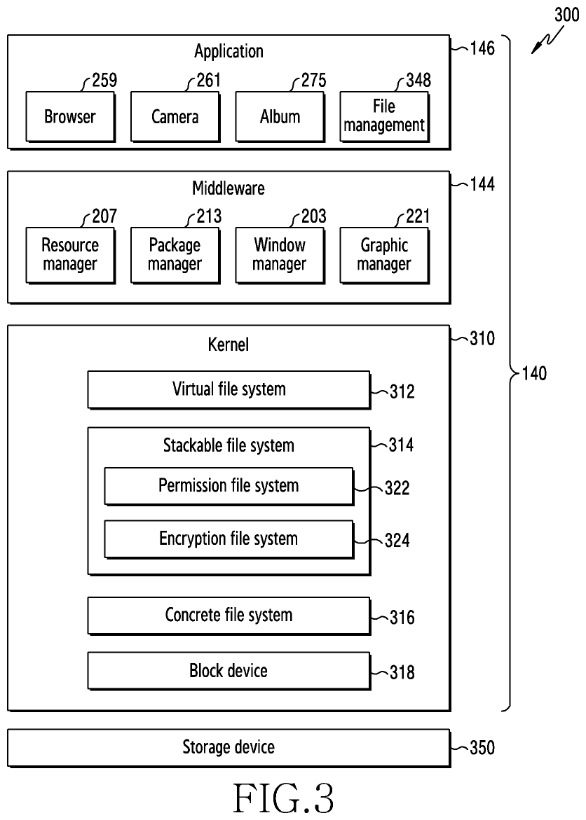

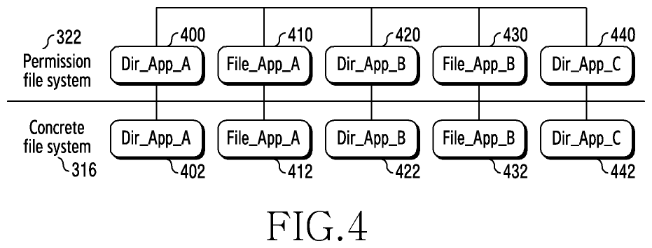

FIG. 3 is a block diagram 300 of a program 140 and a storage device 350 for managing a file associated with an application 146. FIG. 4 is a view illustrating a structure for adding a file associated with an application according to various embodiments of the disclosure.

Referring to FIGS. 3 and 4, the program 140 according to various embodiments of the disclosure may include a kernel 310, middleware 144 (for example, a framework), and/or an application 146. In the following description, the same elements as those of the program 140 of FIG. 2 will not be described in detail. In the following description, terms used in Linux or Unix will be described, but the corresponding terms may be changed based on operating systems of other systems. For example, the kernel 310 may be referred to as an operating system (for example, the operating system 142 of FIG. 2) or may be included in the operating system. For example, at least a portion of the program 140 may be implemented (for example, executed) by software, firmware, hardware (for example, the processor 120 of FIG. 1), or a combination of at least two of these, and may include a module, a program, a routine, a set of instructions, or a process for performing one or more functions.

According to an embodiment, the kernel 310 may include a virtual file system 312, a stackable file system 314, a concrete file system 316, and a block device 318. According to an embodiment, the virtual file system 312 may operate as an interface to connect the application 146 and a file system (for example, the stackable file system 314, etc.). The virtual file system 312 may control to access at least one different file system in the application 146 or the middleware 144. For example, when the virtual file system 312 receives a control command of the application 146 through the middleware 144, the virtual file system 312 may provide the corresponding control command to a file system (for example, the stackable file system 314, etc.) corresponding to the control command. The virtual file system 312 may provide data received from a file system (for example, the stackable file system 314, etc.) to the application 146 through the middleware 144. According to an embodiment, the stackable file system 314 may perform pre-processing and/or post-processing for operating the concrete file system 316 between the virtual file system 312 and the concrete file system 316. For example, the stackable file system 314 may include a permission file system 322 to manage permission of a file (or a folder (directory)) stored in the storage device 350, and an encryption file system 424 to encrypt file data. For example, the permission file system 322 may include an SD card file system (sdcards fs). According to an embodiment, the concrete file system 316 may generate, delete, read or write a file (or a folder) in the storage device 350 through the block device 318. For example, the concrete file system 316 may include an ext4 file system. According to an embodiment, the block device 318 may manage a file (or folder) stored in the storage device 350 (for example, the non-volatile memory 134 of FIG. 1) on a block basis. For example, the block device 318 may include a driver corresponding to the storage device 350.

According to an embodiment, the application 146 may access other file systems 314, 316 of the kernel 310 through the virtual file system 312 to store a file (or a folder) in the storage device 350, or to access a file stored in the storage device 350. According to an embodiment, the permission file system 322 may add information (for example, identification information) of the application 146 to a file generated or accessed by the application 146. According to an embodiment, the permission file system 322 may store a file (or a folder) associated with the application 146 in a specific folder associated with the application 146 (for example, a folder designated in the application, an uppermost folder (for example, a root folder) or a shared folder of an internal storage area of an operating system), or may detect access to a file (or a folder) stored in the specific folder. According to an embodiment, the permission file system 322 may add a process name of the application 146 to file metadata of the file associated with the application 146. For example, the process name of the application 146 may include a package name of the application. According to an embodiment, when an application A generates a folder 400 or a file 410 as shown in FIG. 4, the permission file system 322 may tag information (for example, identification information) of the application A to file metadata of the folder 400 or the file 410 generated by the application A, through the concrete file system 316 (402, 412). For example, when an application B reads a folder 420 or a file 430 stored in the storage device 350 as shown in FIG. 4, the permission file system 322 may tag information (for example, identification information) of the application B to file metadata of the folder 420 or the file 430 through the concrete file system 316 (422, 432). For example, when an application C corrects a folder 440 stored in the storage device 350 as shown in FIG. 4, the permission file system 322 may tag information (for example, identification information) of the application C to file metadata of the folder 440 through the concrete file system 316 (442).

According to an embodiment, the permission file system 322 may further add, to the file (or folder) generated or accessed by the application 146, not only the information (for example, identification information) of the corresponding application 146, but also at least one of the number of applications having accessed the corresponding file or setting information of an auto delete function. For example, the permission file system 322 may add, to the file metadata of the file through the concrete file system 316, not only the information of the application 146 but also at least one of the number of at least one application having accessed the corresponding file (or file) or the setting information of the auto delete function. For example, the auto delete function refers to a function of automatically deleting a file associated with an application when the application is deleted, and may be set by a user input or may be set based on an attribute (for example, a type, a service type) of an application.

According to an embodiment, the permission file system 322 may identify a file (or a folder) associated with a deleted application, based on application information (for example, identification information) added to the file (or folder) stored in the storage device 350. For example, when a specific application is deleted in the application 146, a package manager 213 of the middleware 144 may transmit identification information (for example, an application name and/or a use identifier (UID), etc.) of the deleted application to the permission file system 322. The permission file system 322 may identify a file that includes the identification of the deleted application in file metadata, from among at least one file included in a designated folder (for example, an application-dedicated folder, a root folder, or a shared folder). The permission file system 322 may delete the file including the identification information of the deleted application through the concrete file system 316. For example, the permission file system 322 may delete the identification information of the deleted application from the file metadata of the file associated with the deleted application through the concrete file system 316. Alternatively, when file metadata of a file does not include identification information of an application having accessed the corresponding file, the permission file system 322 may delete the corresponding file.

According to an embodiment, a file management application 348 may display the file (or folder) associated with the deleted application. For example, when a file list is displayed, the file management application 348 may identify a file (or a folder) associated with an application that is not installed in the electronic device 101 through the permission file system 322. The file management application 348 may display the file (or folder) associated with the application that is not installed in the electronic device 101 to be distinguished from the file (or folder) associated with the application installed in the electronic device 101 through a display device (for example, the display device 160 of FIG. 1). Alternatively, the file management application 348 may display a list of the file (or folder) associated with the application that is not installed in the electronic device 101 through the display device 160. The file (or folder) associated with the application that is not installed in the electronic device 101 may include a file (or a folder) including identification information of the application that is not installed in the electronic device 101 or a file (or a folder) that does not include identification information of an application having accessed the corresponding file (or folder) in file metadata of the file (or folder).

According to various embodiments, the electronic device 101 may include: a communication circuit (for example, the communication circuit 190 of FIG. 1); a processor (for example, the processor 120 of FIG. 1) operatively connected with the communication circuit; and a nonvolatile memory (for example, the nonvolatile memory 134 of FIG. 1) electrically connected with the processor, and the memory may store instructions that, when executed, cause the processor to: download at least one application program from an external server through the communication circuit; install the at least one application program in the electronic device; provide a file system which is configured to store at least one file that is used by the at least one application program in at least one first region of the nonvolatile memory; store metadata associated with the at least one file in at least one second region of the nonvolatile memory by using the file system, the metadata including information of the at least one application program; delete the at least one application program from the electronic device; and, in the middle of deleting the at least one application program or after deleting, delete the at least one file based on at least a portion of the metadata.

According to various embodiments, the information of the at least one application program may include usage information associated with the at least one application program.

According to various embodiments, the file system may include a file system of Unix or Linux, and the first region may include a data block and the second region may include an inode list.

According to various embodiments, the inode list may include an extended attribute region.

According to various embodiments, at least a portion of the second region may be included in the first region.

According to various embodiments, the instructions may cause the processor to: in the middle of deleting the at least one application program or after deleting, delete the information of the at least one application program from the metadata associated with the at least one file; determine whether the metadata associated with the at least one file includes information of another application program; and, when the information of another application program is not included, delete the at least one file.

According to various embodiments, the instructions may cause the processor to: in the middle of deleting the at least one application program or after deleting, delete the information of the at least one application program from the metadata associated with the at least one file; identify a number of pieces of information of the application program included in the metadata associated with the at least one file; and delete the at least one file based on the number of pieces of information of the application program included in the metadata.

According to various embodiments, the instructions may cause the processor to: in the middle of deleting the at least one application program or after deleting, identify at least one file including the information of the at least one application program; identify whether the at least one file is deletable; and, when the at least one file is deletable, delete the at least one file.

According to various embodiments, the electronic device may further include a display device (for example, the display device 160 of FIG. 1), and the instructions may cause the processor to: in the middle of deleting the at least one application program or after deleting, identify at least one file including the information of the at least one application program; and display the at least one file to be distinguished from other files through the display device.

According to various embodiments, the file system may include a permission file system (for example, the permission file system 322 of FIG. 3).

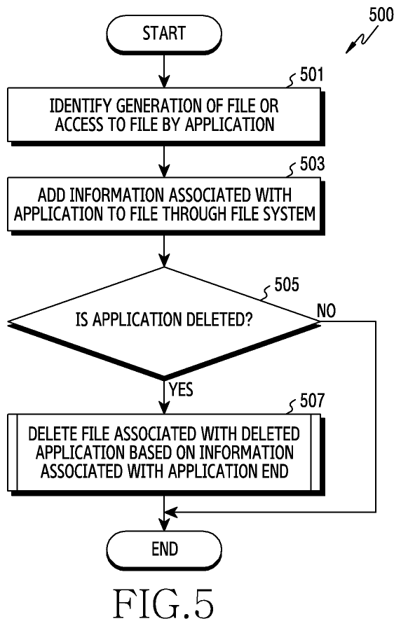

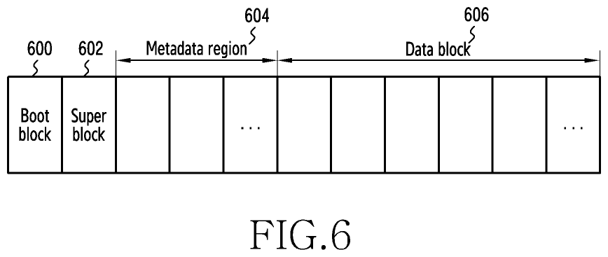

FIG. 5 is a flowchart 500 for managing a file associated with an application in an electronic device 101 according to various embodiments of the disclosure. FIG. 6 is a view illustrating a structure on a disk of a file system according to various embodiments of the disclosure. In the following description, the electronic device may include the electronic device 101 of FIG. 1 or at least a portion (for example, the processor 120) of the electronic device 101. According to various embodiments, operations 501 to 507 may be performed through any one of the electronic device 101, the processor 120, or the program 120.

Referring to FIGS. 5 and 6, in operation 501, the electronic device according to various embodiments may identify generation of a file (or a folder) and access to the file (or use information) by an application installed in the electronic device. For example, the processor 120 may identify a file (or a folder) generated by the application 146 based on a control command (for example, write) of the application 146 that is provided from the virtual file system 312, through the stackable file system 314 (for example, the permission file system 322). For example, the processor 120 may identify access to a file (or folder) stored in the storage device 350 by the application 146 based on a control command (for example, read) of the application 146 that is provided from the virtual file system 312, through the stackable file system 146. For example, when a photo file is accessed in an album application 275 of FIG. 3, the processor 120 may identify access to the photo file stored in the storage device 350 by the album application 275, based on a read control command of the album application 275 that is provided form the virtual file system 312, through the stackable file system 314.

According to various embodiments, in operation 503, the electronic device may add information (for example, identification information) associated with the application to the file (or folder) generated or accessed by the application through the file system. For example, the processor 120 may add the identification information of the application to file metadata of the file (or folder) which is generated by the application 146 or access to which is detected, through the concrete file system 316. According to an embodiment, the file metadata may further include at least one of the number of applications to which identification information is tagged, or setting information of an auto delete function of data. According to various embodiments of the disclosure, the file metadata may be referred to as an inode or a file allocation table (FAT) based on a type of the file system. For example, a file stored in the storage device 350 by the concrete file system 316 may be stored in at least some of a boot block 600, a super block 602, a metadata region 604, and a data block region 606 as shown in FIG. 6. The metadata region 604 may include at least one file metadata for managing user data of respective files included in the data block region 606. The metadata region 604 may include a plurality of file metadata in one block, and, when the metadata region 604 is insufficient, an additional region (for example, the data block region 606) may be allocated and may store the file metadata. The metadata region 604 is to store file metadata associated with user data of a file, and may include information such as a file format, an access authority, a file owner, a file size, a change time, an access time, a file location, or an extended attribute region. The extended attribute region may include at least one of identification information of an application associated with the corresponding file, the number of applications to which identification information is tagged, or setting information of an auto delete function. For example, in the case of Unix or Linux, the metadata region 604 may include an inode list including at least one inode. In addition, the inode list may further include an extended attribute region (for example, xattrs) (not shown). The extended attribute region of the inode may enable data to be freely written in the file system, and may add information (for example, identification information) associated with the application to a corresponding region. The boot block 600 according to various embodiments may include information (for example, a program) for loading corresponding data from the operating system of the electronic device 101 onto a main memory device. The super block 602 may include information of at least one of the total number of blocks of the file system, a size of a block, the number of blocks in use, a number of a usable block, a size of the meta data region 604, or a number of the usable meta data region 604. The data block region 606 may include at least one data block and may store user data of a file associated with an application. Although the operating system of Unix or Linux is illustrated by way of an example as described above, the disclosure is not limited thereto and is equally applied to various operating systems.

According to various embodiments, in operation 505, the electronic device may identify whether at least one application is deleted from among the plurality of applications installed in the electronic device. For example, the processor 120 may determine whether a delete input corresponding to at least one application is detected through the package manager 213. For example, the processor 120 may determine whether the delete input corresponding to the at least one application is received from an external device (for example, the electronic device 102, 104 of FIG. 1, the server 106) through the communication module 180.

According to various embodiments, when at least one application is deleted, the electronic device may delete a file (or a folder) associated with the application based on information (for example, identification information) associated with the application in operation 507. For example, when identification information of the application deleted in the electronic device 101 is received from the package manager 334 of the middleware 144, the processor 120 may identify a file including the identification information of the deleted application in the storage device 350 through the stackable file system 314 (for example, the permission file system 322). The processor 120 may delete the file including the identification information of the deleted application from the storage device 250, through the concrete file system 316. For example, the processor 120 may delete the identification information of the application deleted in the electronic device 101 from file metadata of the file stored in the storage device 350 through the concrete file system 316. The processor 120 may delete, from the storage device 350 through the concrete file system 316, a file that does not include identification of an application in file metadata.

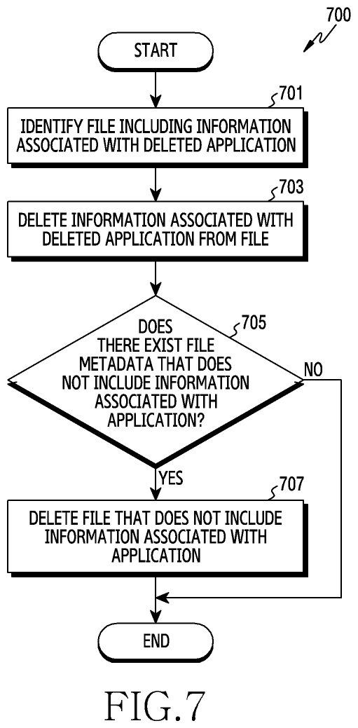

FIG. 7 is a flowchart 700 for managing a file based on another application information in an electronic device 101 according to various embodiments of the disclosure. The following description may be about the operation of deleting data associated with the deleted application in operation 507 of FIG. 5 according to an embodiment. In the following description, the electronic device may include the electronic device 101 of FIG. 1 or at least a portion (for example, the processor 120) of the electronic device 101. According to various embodiments, operations 701 to 707 may be executed through any one of the electronic device 101, the processor 120, or the program 120.

Referring to FIG. 7, when at least one application is deleted in the electronic device (for example, operation 505 of FIG. 5), the electronic device according to various embodiments may identify a file (or a folder) including information associated with the application deleted in the electronic device in operation 701. For example, the processor 120 may identify a file in which identification information of the application deleted in the electronic device 101 is tagged to file metadata, from among files stored in the storage device 350, through the stackable file system 314 (for example, the permission file system 322). The processor 120 may acquire the identification information of the application deleted in the electronic device 101 from the package manager 213 of the middleware 144.

According to various embodiments, in operation 703, the electronic device may delete information associated with the application deleted in the electronic device from at least one file stored in the electronic device (storage device 350). For example, the processor 120 may delete the identification information of the application deleted in the electronic device 101 from file metadata of the file associated with the application deleted in the electronic device 101, which is stored in the storage device 350, through the concrete file system 316.

According to various embodiments, in operation 705, the electronic device may identify whether there exists file metadata that does not include application identification information. For example, the processor 120 may identify the number of applications of file metadata that is included in a metadata region (for example, the metadata region 604 of FIG. 6) through the stackable file system 314 (for example, the permission file system 322). For example, the processor 120 may determine file metadata having zero number of applications as not including application identification information. For example, when the number of applications is 1 or more, the processor 120 may determine that there exists application identification information in corresponding file metadata.

According to various embodiments, when there exists file metadata that does not include application identification information, the electronic device may delete the file (or folder) including the file metadata that does not include the application identification information in operation 707. For example, the processor 120 may delete the file (or folder) including the file metadata that does not include identification information of an application from the storage device 350 through the concrete file system 316.

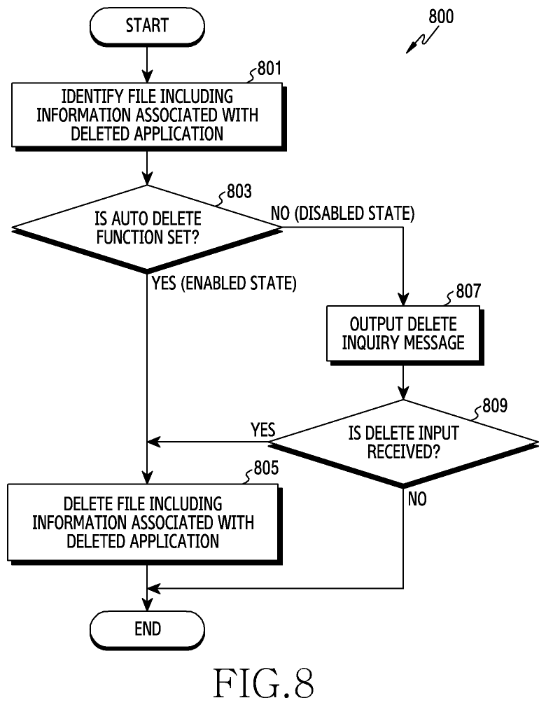

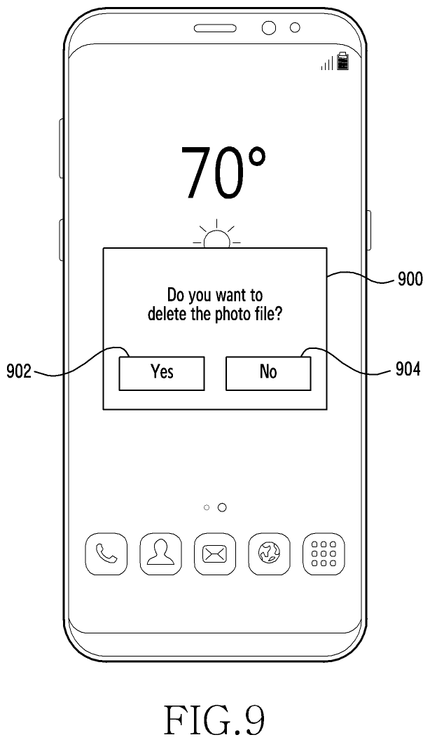

FIG. 8 is a flowchart 800 for managing a file based on an auto setting function in the electronic device 101 according to various embodiments of the disclosure. FIG. 9 is a view illustrating a configuration of a delete inquiry message according to various embodiments of the disclosure. The following description may be about the operation of deleting data associated with the deleted application in operation 507 of FIG. 5 according to an embodiment. In the following description, the electronic device may include the electronic device 101 of FIG. 1 or at least a portion (for example, the processor 120) of the electronic device 101. According to various embodiments, operations 801 to 809 may be executed through any one of the electronic device 101, the processor 120, or the program 120.

Referring to FIGS. 8 and 9, when at least one application is deleted in the electronic device (for example, operation 505 of FIG. 5), the electronic device according to various embodiments may identify a file (or a folder) including information (for example, identification information) associated with the application deleted in the electronic device, from among files (or folders) stored in the storage device in operation 801. For example, the processor 120 may receive the identification information of the application deleted in the electronic device 101 from the package manager 213 of the middleware 144. The processor 120 may identify a file (or a folder) in which the identification information of the application deleted in the electronic device 101 is tagged to file metadata through the stackable file system 314 (for example, the permission file system 322).

According to various embodiments, the electronic device may identify whether an auto delete function is set in the file including the information associated with the application detected in the electronic device in operation 803. For example, the processor 120 may identify whether the corresponding file of the file metadata to which the identification information of the application deleted in the electronic device 101 is tagged is deletable, through the stackable file system 314 (for example, the permission file system 322).

According to various embodiments, when the auto delete function of the file including the information associated with the application deleted in the electronic device is set to be enabled (“Yes” in operation 803), the electronic device may delete the file (or folder) in which the information associated with the application deleted in the electronic device is tagged to file metadata, from among the files stored in the storage device in operation 805. According to another embodiment, the processor 120 may delete the identification information of the application deleted in the electronic device 101, from the file metadata of the file associated with the application deleted in the electronic device 101, as in operations 701 to 707 of FIG. 7. When there does not exist identification information of an application included in file metadata of a corresponding file, the processor 120 may delete the corresponding file from the storage device 350.

According to various embodiments, when the auto delete function corresponding to the file (or folder) including the information associated with the application deleted in the electronic device is set to be disabled (“No” in operation 803), the electronic device may output a delete inquiry message in operation 807. For example, when the auto delete function on the file (or folder) in which the identification information of the application deleted in the electronic device 101 is tagged to the file metadata is set to be disabled, the processor 120 may display a delete inquiry message 900 through the display device 160 as shown in FIG. 9. For example, the delete inquiry message 900 may be displayed on at least a portion of the display device 160 in the form of a pop-up window.

According to various embodiments, the electronic device may identify whether a delete input corresponding to the delete inquiry message is received in operation 809. For example, the delete inquiry message 900 displayed on the display device 160 may include a confirmation (Yes) menu 902 or a cancel (No) menu 904. The processor 120 may determine whether an input (for example, a touch input) corresponding to the confirmation (Yes) menu 902 is received in the delete inquiry message 900 displayed on the display device 160.

According to various embodiments, when the delete input corresponding to the delete inquiry message is received (“Yes” in operation 809), the electronic device may delete data corresponding to the delete inquiry message from the files (or folders) stored in the storage device in operation 805. For example, when an input corresponding to the confirmation (Yes) menu 902 is received in the delete inquiry message 900, the processor 120 may delete a file (or a folder) corresponding to the delete inquiry message 900 from the files (or folders) stored in the storage device 350 through the concrete file system 316. For example, the data corresponding to the delete inquiry message 900 may include a file (or a folder) including identification information of the application deleted in the electronic device 101.

According to various embodiments, when a cancel input corresponding to the delete inquiry message is received, the electronic device may determine to maintain the file (or folder) corresponding to the delete inquiry message. For example, when an input corresponding to the cancel (No) menu 904 is received in the delete inquiry message 900, the processor 120 may maintain the file (or folder) corresponding to the delete inquiry message 900, which is stored in the storage device 350, through the concrete file system 316.

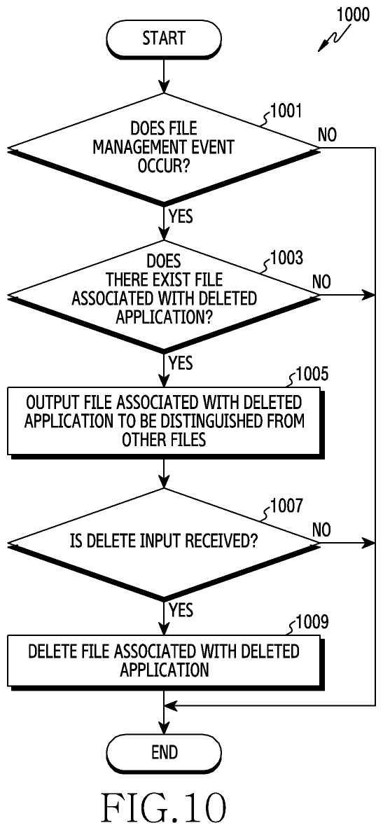

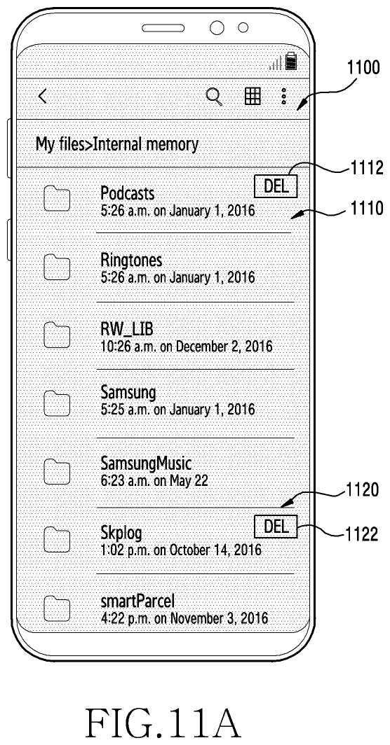

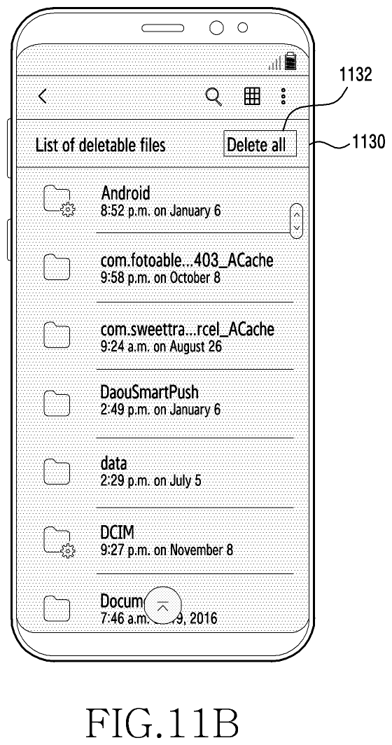

FIG. 10 is a flowchart 1000 for displaying a deletable file to be distinguished in a file list in an electronic device 101 according to various embodiments of the disclosure. FIGS. 11A to 11B are views illustrating a configuration of a file list including a deletable file according to various embodiments of the disclosure. In the following description, the electronic device may include the electronic device 101 of FIG. 1 or at least a portion (for example, the processor 120) of the electronic device 101. According to various embodiments, operations 1001 to 1009 may be executed through any one of the electronic device 101, the processor 120, or the program 120.

Referring to FIGS. 10 to 11B, the electronic device according to various embodiments may determine whether an event for managing a file (or a folder) stored in the electronic device occurs in operation 1001. For example, the processor 120 may determine whether a select input on an icon corresponding to the file management application 348 displayed on the display device 160 is detected through the input device 150. For example, the file management application may display a list of files (or folders) stored in the storage device 350 through the display device 160, such that the files (or folders) stored in the storage device (the storage device 350 of FIG. 3) can be identified or controlled by a user.

According to various embodiments, when the event for managing the file occurs (“Yes” in operation 1001), the electronic device may determine whether there exists a file (or a folder) associated with an application deleted in the electronic device, from among the files (or folders) stored in the electronic device in operation 1003. For example, the processor 120 (for example, the file management application 348 of FIG. 3) may determine whether there exists a file (or a folder) that includes identification information of an application in file metadata, in addition to identification information of an application installed in the electronic device 101, from among the files (or folders) stored in the storage device 350, through the stackable file system 314 (for example, the permission file system 322 of FIG. 3). In another example, the processor 120 (for example, the file management application 348) may determine whether there exists a file (or a folder) that includes file metadata in which identification information of an application does not exist, from among the files (or folders) stored in the storage device 350, through the stackable file system 314 (for example, the permission file system 322). For example, the processor 120 may determine the number of applications including identification information in corresponding file metadata, based on information on the number of applications of file metadata.

According to various embodiments, when there does not exist the file (or folder) associated with the application deleted in the electronic device (“No” in operation 1003), the electronic device may output the list of the files (or folders) stored in the storage device.

According to various embodiments, when there exists file (or folder) data associated with the application deleted in the electronic device (“Yes” in operation 1003), the electronic device may output the file (or folder) associated with the application deleted in the electronic device to be distinguished from a file (or a folder) associated with an application installed in the electronic device in operation 1005. For example, the processor 120 (for example, the file management application 348) may display a list 1100 of files (or folders) associated with the application 146 stored in the storage device 350 through the display device 160, as shown in FIG. 11A. When applications associated with a first folder 1110 (for example, a podcasts folder) and a second folder 1120 (for example, a skplog folder) are deleted, the processor 120 (for example, the file management application 348) may display delete icons 1112, 1122 on the first folder 1110 and the second folder 1120.

According to various embodiments, in operation 1007, the electronic device may determine whether a delete input on the file (or folder) associated with the application deleted in the electronic device is received. For example, the processor 120 may determine whether an input (for example, a touch input) corresponding to the delete icon 1112, 1122 is received in the data list 1100 displayed on the display device 160 as shown in FIG. 11A.

According to various embodiments, when the delete input corresponding to the file (or folder) associated with the application deleted in the electronic device is received (“Yes” in operation 1007), the electronic device may delete the file (or folder) corresponding to the delete input from among the files (or folders) stored in the storage device in operation 1009. For example, the processor 120 may delete the file (or folder) corresponding to the delete icon 1112 or 1122 on which a select input is received, from among the files (or folders) stored in the storage device 350, through the concrete file system 316.

According to an embodiment, the electronic device may display a list of a file (or folder) associated with the application deleted in the electronic device. For example, when the file management application 348 is driven, the processor 120 may detect a file (or a folder) associated with the application deleted in the electronic device 101 from among the files (or folders) stored in the storage device 350. As shown in FIG. 11B, the processor 120 may display a list 1130 of the file (or folder) associated with the application deleted in the electronic device 101 through the display device 160. When a select input on a delete all icon 1132 displayed on at least a portion of the display device 160 is detected, the processor 120 may delete all files (or folders) displayed on the display device 160. For example, the list 1130 of the file (or folder) associated with the application deleted in the electronic device 101 may include at least one deletable file (or folder). The at least one deletable file (or folder) may include a file (or a folder) that includes identification information of an application in file metadata, in addition to identification information of an application installed in the electronic device 101, or a file (or folder) that includes file metadata in which identification information of an application does not exist.

According to various embodiments of the disclosure, an operating method of an electronic device 101 may include: storing, through a file system of the electronic device, at least one file that is used by at least one application program in at least one first region of a nonvolatile memory; storing metadata associated with the at least one file in at least one second region of the nonvolatile memory by using the file system, the metadata including information of the at least one application program; and, in response to the at least one application program being deleted from the electronic device, deleting the at least one file based on at least a portion of the metadata.

According to various embodiments, the information of the at least one application program may include usage information associated with the at least one application program.

According to various embodiments, the file system may include a file system of Unix or Linux, and the first region may include a data block and the second region may include an inode list.

According to various embodiments, the inode list may include an extended attribute region.

According to various embodiments, at least a portion of the second region may be included in the first region.

According to various embodiments, deleting the at least one file may include: in the middle of deleting the at least one application program or after deleting, deleting the information of the at least one application program from the metadata associated with the at least one file; determining whether the metadata associated with the at least one file includes information of another application program; and, when the information of another application program is not included, deleting the at least one file.

According to various embodiments, deleting the at least one file may include: in the middle of deleting the at least one application program or after deleting, deleting the information of the at least one application program from the metadata associated with the at least one file; identifying a number of pieces of information of the application program included in the metadata associated with the at least one file; and deleting the at least one file based on the number of pieces of information of the application program included in the metadata.

According to various embodiments, deleting the at least one file may include: in the middle of deleting the at least one application program or after deleting, identifying at least one file including the information of the at least one application program; identifying whether the at least one file is deletable; and, when the at least one file is deletable, deleting the at least one file.

According to various embodiments, the method may further include: in the middle of deleting the at least one application program or after deleting, identifying at least one file including the information of the at least one application program; and displaying the at least one file to be distinguished from other files.

According to various embodiments of the disclosure, a non-transitory computer-readable storage medium may store one or more programs for executing: storing, through a file system of the electronic device, at least one file that is used by at least one application program in at least one first region of a nonvolatile memory; storing metadata associated with the at least one file in at least one second region of the nonvolatile memory by using the file system, the metadata including information of the at least one application program; and, in response to the at least one application program being deleted from the electronic device, deleting the at least one file based on at least a portion of the metadata.

While various embodiments of the disclosure have been described, various changes can be made without departing from the scope of various embodiments of the disclosure. Therefore, the scope of various embodiments of the disclosure is defined not by the described embodiments but by the appended claims and equivalents to the scope of the claims.

1. An electronic device comprising:
a communication circuit;
a processor operatively connected with the communication circuit; and
a nonvolatile memory electrically connected with the processor,
wherein the memory stores instructions that, when executed, cause the processor to:
download at least one application program from an external server through the communication circuit;
install the at least one application program in the electronic device;
provide a file system which is configured to store at least one file that is used by the at least one application program in at least one first region of the nonvolatile memory;
metadata associated with the at least one file in at least one second region of the nonvolatile memory by using the file system, the metadata comprising information of the at least one application program;
delete the at least one application program from the electronic device; and
in the middle of deleting the at least one application program or after deleting, delete the at least one file based on at least a portion of the metadata.

2. The electronic device of claim 1, wherein the information of the at least one application program comprises usage information associated with the at least one application program.

3. The electronic device of claim 1,
wherein the file system comprises a file system of Unix or Linux,
wherein the first region comprises a data block, and
wherein the second region comprises an inode list.

4. The electronic device of claim 1, wherein the instructions cause the processor to:
in the middle of deleting the at least one application program or after deleting, delete the information of the at least one application program from the metadata associated with the at least one file;
determine whether the metadata associated with the at least one file comprises information of another application program; and
when the information of another application program is not included, delete the at least one file.

5. The electronic device of claim 1, wherein the instructions cause the processor to:
in the middle of deleting the at least one application program or after deleting, delete the information of the at least one application program from the metadata associated with the at least one file;
identify a number of pieces of information of the application program included in the metadata associated with the at least one file; and
delete the at least one file based on the number of pieces of information of the application program included in the metadata.

6. The electronic device of claim 1, wherein the instructions cause the processor to:
in the middle of deleting the at least one application program or after deleting, identify at least one file comprising the information of the at least one application program;
identify whether the at least one file is deletable; and
when the at least one file is deletable, delete the at least one file.

7. The electronic device of claim 1, further comprising a display device,
wherein the instructions cause the processor to:
in the middle of deleting the at least one application program or after deleting, identify at least one file comprising the information of the at least one application program; and
display the at least one file to be distinguished from other files through the display device.

8. The electronic device of claim 1, wherein the file system comprises a permission file system.

9. An operating method of an electronic device, the method comprising:
storing, through a file system of the electronic device, at least one file that is used by at least one application program in at least one first region of a nonvolatile memory;
storing metadata associated with the at least one file in at least one second region of the nonvolatile memory by using the file system, the metadata comprising information of the at least one application program; and
in response to the at least one application program being deleted from the electronic device, deleting the at least one file based on at least a portion of the metadata.

10. The method of claim 9, wherein the information of the at least one application program comprises usage information associated with the at least one application program.

11. The method of claim 9,
wherein the file system comprises a file system of Unix or Linux,
wherein the first region comprises a data block, and
wherein the second region comprises an inode list.

12. The method of claim 9, wherein deleting the at least one file comprises:
in the middle of deleting the at least one application program or after deleting, deleting the information of the at least one application program from the metadata associated with the at least one file;
determining whether the metadata associated with the at least one file comprises information of another application program; and
when the information of another application program is not included, deleting the at least one file.

13. The method of claim 9, wherein deleting the at least one file comprises:
in the middle of deleting the at least one application program or after deleting, deleting the information of the at least one application program from the metadata associated with the at least one file;
identifying a number of pieces of information of the application program included in the metadata associated with the at least one file; and
deleting the at least one file based on the number of pieces of information of the application program included in the metadata.

14. The method of claim 9, wherein deleting the at least one file comprises:
in the middle of deleting the at least one application program or after deleting, identifying at least one file comprising the information of the at least one application program;
identifying whether the at least one file is deletable; and
when the at least one file is deletable, deleting the at least one file.

15. The method of claim 9, further comprising:
in the middle of deleting the at least one application program or after deleting, identifying at least one file comprising the information of the at least one application program; and
displaying the at least one file to be distinguished from other files.
